(19) United States
(12) Patent Application Publication
(10) Pub. No.: US 2004/0064208 A1
(43) Pub. Date: Apr. 1, 2004

(54) Dual mode store and play digital audio broadcast (DAB) receiver

(76) Inventors: Deepen Sinha, (US); James Tracey, (US)

Correspondence Address: Blaney Harper, Jones, Day, Reavis & Pogue, 51 Louisiana Ave., NW, Washington, DC, 20001-2113, US

(21) Appl. No.: 10/259,073

(22) Filed: Sep. 27, 2002

(51) Int. Cl. H04H 5/00; G06F 17/00

(52) U.S. Cl. 700/94; 381/2

(57) ABSTRACT

A dual-mode receiver that functions both as a digital audio broadcast receiver and a solid-state digital audio content player is described. In a “radio” mode, the receiver is able to: receive a digital audio bitstream, decode the received bitstream, store or render the decoded bitstream either based on an input from a user or a pre-programmed instruction from a user. In a “play” mode, the receiver is able to access the stored digital audio content, or extract stored digital audio content from a compact media device (e.g., compact flash memory) that is interfaced with the receiver.

### FIELD OF INVENTION

The present invention relates generally to the field of broadcasting. More specifically, the present invention is related to digital audio broadcast receivers.

### BACKGROUND OF THE INVENTION

Compact digital music players are becoming increasingly popular in today's world. A distinguishing feature in such players is the audio coding or audio compression format that is supported. For example, a common audio compression format supported in digital players is the MP3 format. Audio compression schemes offer a delicate balance between quality of the compressed digital content and size of such compressed digital content. Thus, if a high quality is required, then a sacrifice is made in the size of the compressed contents (a great deal of compression is not achieved if high quality is required). On the other hand, if low or mediocre quality is required, then a great deal of compression can be achieved.

Formats such as MP3 compress content using perceptual audio coding (PAC) and psychoacoustic compression to remove all superfluous information, more specifically, the redundant and irrelevant parts of a sound signal. The result in real terms is such compression schemes shrinks the original sound data from a CD with a bitrate of 1411.2 kilobits per second (bitrate denotes the average number of bits that one second of audio data will consume) of stereo music by a factor of 12 (down to 112-128 kbps) without sacrificing sound quality. Furthermore, since files based on compression formats such as MP3 are small, they can be transferred across the Internet (via digital broadcasts), and can be stored in a compact digital music player with a relatively small amount of storage space.

As mentioned earlier, a number of solid-state playback devices are proliferating in the market. These devices, often based on the popular MP3 music format, playback digital music stored on a storage device (e.g., memory stick or a MP3 player). An example of how such content is transferred in prior art systems is shown in FIG. 1. In this example, audio content is downloaded to the storage device/player 100 via one of the following mechanism: 1) via a network 102 such as the Internet, or 2) via a storage device (such as a CD-ROM) in the computer 104.

For example, previously encoded audio content can be downloaded via a network 102 such as the Internet onto a personal computer (PC), and such content can be transferred to a storage device/player 100 at a later time. Another option could be encoding audio content in an optical storage device (e.g., a CDROM) 104 and transferring such encoded audio content onto storage device/player 100. Playback devices, however, are very restricted in how the content is transferred onto them. The playback devices described in the prior art are restricted to content stored within and are unable to intercept, render or store broadcast digital content.

### SUMMARY OF THE INVENTION

The present invention provides for a receiver that is capable of functioning in dual modes: “radio” mode and “play” mode. In the radio mode, the receiver of the present invention is able to receive digital audio broadcast data (broadcast over a network such as an in-band on-channel or IBOC network) and the receiver either renders or stores the received audio data. Broadcast data is rendered via a man machine interface (MMI) that is operatively linked with the receiver. A user of the receiver is also able to record the rendered audio data by the press of a button, or optionally, the user is able to pre-program the receiver to intercept particular digital audio broadcasts programs (e.g., top 40 songs) and the user is able to instruct the receiver to store such broadcast programs. On the other hand, in a “play” mode, the receiver is able to access the stored digital audio content, or optionally, extract stored digital audio content from a compact media device (e.g., compact flash memory) that is interfaced with the receiver.

The receiver of the present invention also allows for mixing the recorded and stored music (obtained via other sources such as Internet downloads) to create personalized playlists. The individualized playlists can then be downloaded to a storage medium (e.g., compact flash memory). This may then be taken back to any digital audio broadcast receiver for playback, eliminating the need for a separate solid-state player. In an extended embodiment, media with customized music selection are purchased in an audio kiosk in a music store or ordered via the Internet and played back using the present invention's receiver. These are then added to a user's music collection for use in the creation of re-customized media.

### BRIEF DESCRIPTION OF THE DRAWINGS

FIG. 1 illustrates a prior art digital audio player.

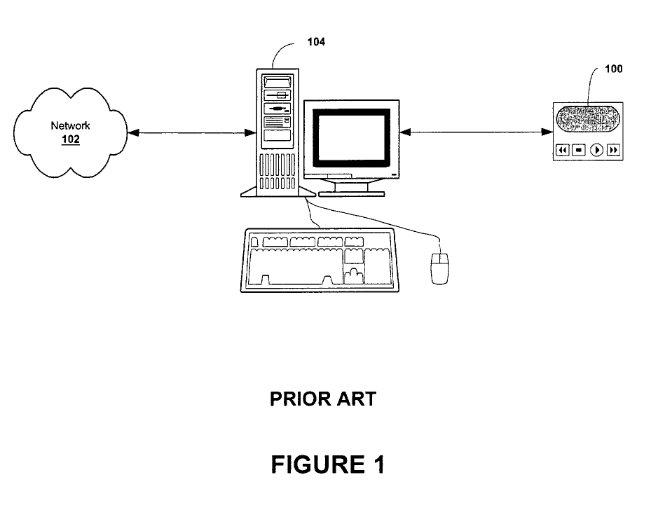

FIG. 2 illustrates the present invention's digital audio broadcast (DAB) receiver.

FIG. 3 illustrates the stored audio bitstream with formatting and fingerprinting information inserted at the beginning of the bitstream.

FIG. 4 illustrates a personal music organizer used in conjunction with the present invention.

### DESCRIPTION OF THE PREFERRED EMBODIMENTS

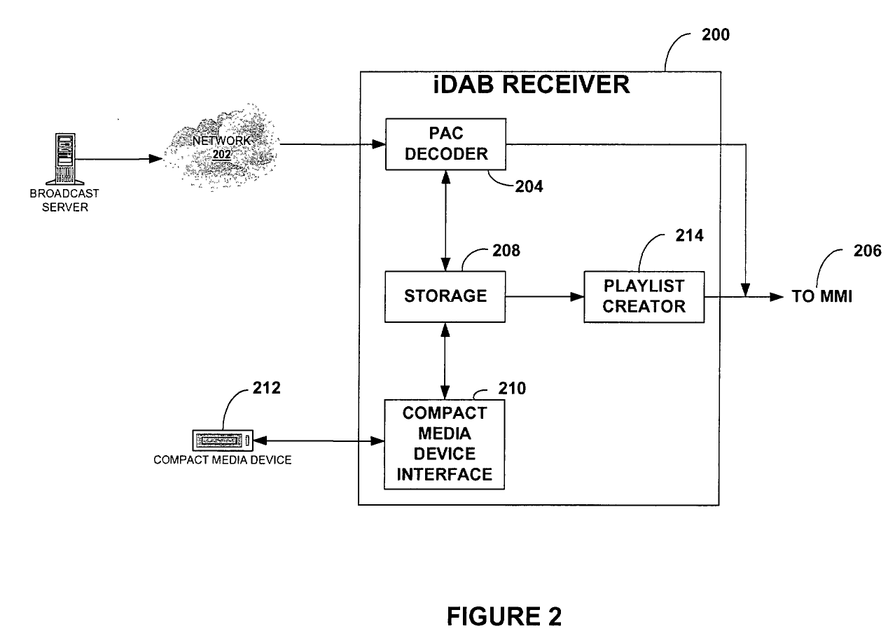

FIG. 2 illustrates the present invention's digital audio broadcast receiver 200 (hereon DAB). Receiver 200 of the present invention is able to:

(a) receive digital audio broadcasts over a network 202 (such as an in-band on-channel or IBOC network);

(b) decode the received broadcast content (via decoder 204) and render the decoded content via a man machine interface (MMI) 206;

(c) store the decoded broadcast content (of interest to a client) in one or more storage units 208;

(d) interface 210 for receiving and extracting (digital audio content) from a compact media device 212, wherein receiver 200 stores the extracted digital data in storage 208; and

(e) create playlists (via playlist creator 214) from audio content in storage and render any audio content related to created playlists via MMI 206.

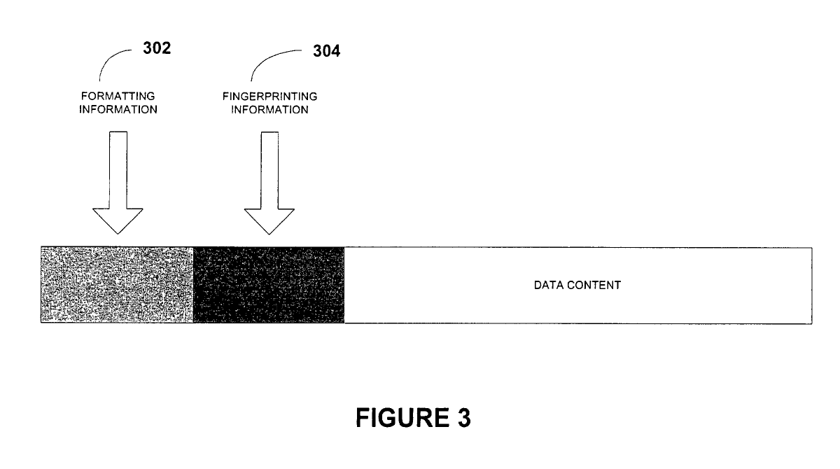

As previously cited, the DAB receiver operates in two modes: a “radio” mode and a “player” mode. When the DAB receiver is in the “radio” mode and a record command (e.g., button pressed) is received from a user (via the MMI 206), the digital audio bitstream received by the PAC decoder 204 is modified for storage (in storage unit 208) in several ways, some of which are now described. In one embodiment and as illustrated in FIG. 3, the formatting information 302, such as beginning of track, artist/album, track length, etc., is inserted at the beginning of each segment to be recorded (stored).

In another embodiment and as illustrated in FIG. 3, digital fingerprinting information 304 (such as receiver identification) is inserted into the bitstream. This allows for the tracking/copyright assertion as may be required by any legal owners of the audio material. Thus, after modification of the received broadcast content, the bitstream is forwarded to higher protocol layers in the receiver stack (along with the decoded audio), which support an interface to a storage media for potential storage.

As shown in FIG. 2, the DAB receiver of the present invention supports a record feature based on user command (button-press) or a pre-programmed user profile (e.g., record top 40 songs). For example, a user can press a record button in MMI 206 and instruct the receiver 200 to record broadcast content onto storage 208, or on the other hand, the user can pre-program (via the MMI 206 or over a network such as the Internet) a particular broadcast program of interest (for example, the top 40 songs of the week) and instruct the receiver 200 to record and store the noted data content during a broadcast period. In the “play” mode, a direct path is provided to the PAC decoder in the receiver so that the bitstream retrieved from a storage medium may be decoded for playback. In this play mode, the decoder also checks for the validity of the bitstream (e.g., to ensure that these contain a legal digital fingerprint).

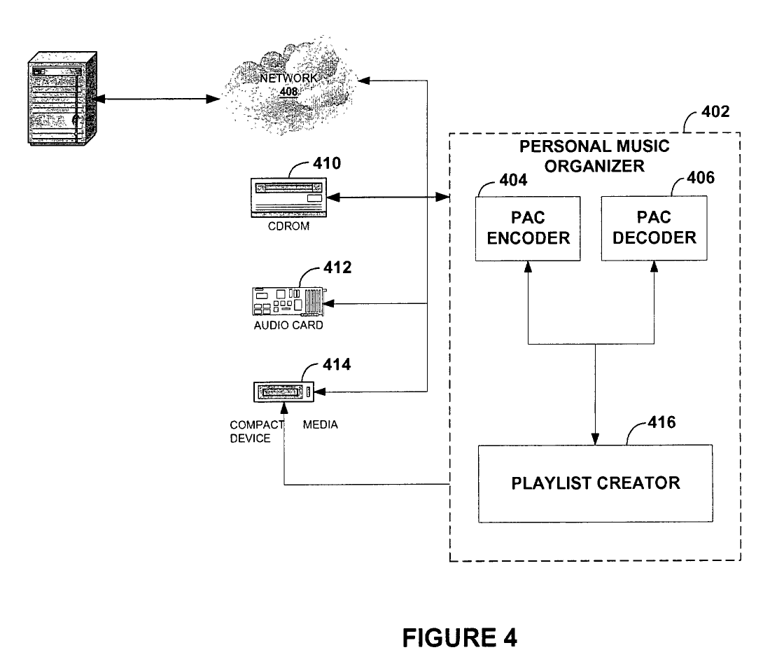

FIG. 4 illustrates a “personal music organizer” (hereon PMO) software interface 402 including a PAC encoder 404 and a PAC decoder 406 that are utilized in conjunction with the receiver of the present invention (for the purpose of manipulating compact media device 212 of FIG. 2). The PMO illustrated in FIG. 4 is installed on a personal computer (PC) and performs the following functions:

(a) The PMO is able to interface with: a network 408 (such as the Internet), a CDROM device 410, an audio card 412, or a compact media device (e.g., a memory stick) 414. Digital audio content is extracted via the interface and onto a host computer running the PMO. For example, audio content can be extracted over the Internet via a network interface.

(b) The PMO allows for the organization of audio content (e.g., music) obtained from various sources (e.g., via the interfaces listed above). This audio content (e.g., music) is internally stored in the PAC format (via encoding by the PAC encoder 404).

(c) The PMO allows for the creation of customized playlists (via playlist creator 416) from the audio content (e.g., music collection).

(d) The PMO allows for the download of any of the playlist onto the media device 414 in a PAC bitstream format suitable for playback on the DAB receiver of FIG. 2.

While the PMO may be implemented in a personal computer, one skilled in the art can envision other systems for implementation of such a software module. For example, a modified version of the PMO software can be implemented in a kiosk based on a high-end workstation/server. The kiosk software is a scaled up version of the PMO for use in “in-store” kiosks as well as web-based servers allowing for the download/purchase of customized music in the PAC format.

A system and method has been shown in the above embodiments for the effective implementation of a basic store and play feature in a digital audio broadcast (DAB) receiver to allow for enhanced consumer music distribution applications. The above enhancements may be implemented in various computing environments. For example, the present invention may be implemented in a multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of digital signal processing and broadcast programming.

While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, or specific hardware.

1. A digital audio broadcast receiver capable of receiving digital audio broadcast content, said receiver comprising:
a. a perceptual audio decoder decoding said received digital audio broadcast content;
b. an interface receiving a compact media device with stored digital audio content, said receiver extracting said stored digital audio content;
c. one or more storage units capable of storing digital audio content comprising said decoded digital audio broadcast content and said extracted stored digital audio content, and
d. a playlist creator operatively linked to said storage units creating a digital audio content playlist based upon said stored digital audio content.

2. A digital audio broadcast receiver capable of receiving digital audio broadcast content, as per claim 1, wherein said receiver further comprises a man machine interface (MMI) for inputting instructions for identifying which of said stored audio content is to form said digital content playlist.

3. A digital audio broadcast receiver capable of receiving digital audio broadcast content, as per claim 1, wherein said compact media device is a memory stick.

4. A digital audio broadcast receiver capable of receiving digital audio broadcast content, as per claim 1, wherein said memory stick is customizable with a user-defined playlist that is purchasable over a kiosk.

5. A digital audio broadcast receiver capable of receiving digital audio broadcast content, as per claim 1, wherein said receiver is capable of receiving broadcast data over an in-band on-channel (IBOC) network.

6. A digital audio broadcast receiver capable of receiving digital audio broadcast content, as per claim 1, wherein said compact media device is pre-programmed with a playlist.

7. A digital audio broadcast receiver capable of receiving digital audio broadcast content, as per claim 1, using said pre-programming is done via personal music organizer software.

8. A digital audio broadcast receiver capable of receiving digital audio broadcast content, as per claim 1, wherein said receiver further comprises a MMI for inputting instructions for identifying one or more broadcast programs of interest, and said receiver intercepting and recording said programs of interest in said storage units.

9. A digital audio broadcast receiver capable of receiving digital audio broadcast content, as per claim 1, wherein said digital audio content stored in said storage units is modified by inserting formatting information at the beginning of each bitstream.

10. A digital audio broadcast receiver capable of receiving digital audio broadcast content, as per claim 1, wherein said formatting information comprises one or a combination of the following: beginning of track, name of artist, name of the album, or track length.

11. A digital audio broadcast receiver capable of receiving digital audio broadcast content, as per claim 1, wherein said digital audio content stored in said storage units is modified by inserting receiver identifying information at the beginning of each bitstream.

12. A method for switching between a “radio” and “play” mode in a digital audio broadcast receiver, said receiver receiving, storing, and playing digital audio content, and
when switched to said radio mode, said method comprising the steps of:
(a) receiving a digital audio broadcast content;
(b) decoding said digital audio broadcast content, and
(c) storing and rendering said decoded digital audio content based upon one or more instructions from an interface, and
when switched to a play mode, said method comprising the steps of:
(a) extracting digital audio content from one or more storage units and a compact media device based upon one or more instructions from an interface;
(b) decoding said extracted digital audio content, and
(c) rendering said decoded digital audio content.

13. A method for switching between a “radio” and “play” mode in a digital audio broadcast receiver, as per claim 12, wherein said compact media device is a memory stick that is customizable with a user-defined playlist.

14. A method for switching between a “radio” and “play” mode in a digital audio broadcast receiver, as per claim 12, wherein said play-list is purchasable over a kiosk.

15. A method for switching between a “radio” and “play” mode in a digital audio broadcast receiver, as per claim 11, wherein said one or more instructions from an interface help generate a playlist comprising said extracted digital content.

16. A method for switching between a “radio” and “play” mode in a digital audio broadcast receiver, as per claim 11, wherein said broadcast content is received over an in-band on-channel (IBOC) network.

17. A method for switching between a “radio” and “play” mode in a digital audio broadcast receiver, as per claim 11, wherein said interface is used to input and identify one or more broadcast programs of interest, and said receiver intercepting and storing said programs of interest in said one or more storage units.

18. A method for switching between a “radio” and “play” mode in a digital audio broadcast receiver, as per claim 11, wherein said digital audio content stored in said storage units is modified by inserting formatting information at the beginning of each bitstream.

19. A method for switching between a “radio” and “play” mode in a digital audio broadcast receiver, as per claim 16, wherein said formatting information comprises any of the following: beginning of track, name of artist, name of the album, or track length.

20. A method for switching between a “radio” and “play” mode in a digital audio broadcast receiver, as per claim 11, wherein said digital audio content stored in said storage units is modified by inserting receiver identifying information at the beginning of each bitstream.

21. A method for switching between a “radio” and “play” mode in a digital audio broadcast receiver, as per claim 11, wherein said interface is any of the following: aural, graphical, or a combination of aural and graphical interfaces.

22. A dual mode digital broadcast receiver having a play mode and a record mode, said receiver comprising:
a. a storage media interface for extracting storage content from a compact media device;
b. a PAC decoder for decoding digital broadcast content and said extracted storage content;
c. one or more storage units for storing said decoded content;
d. a recording unit, when in record mode, triggering storage of said decoded digital broadcast content in said one or more storage units;
e. a reproducing unit, when in play mode, rendering either said decoded digital broadcast content in said storage units or said extracted storage content;
f. a user interface unit for receiving user commands, said user commands controlling the operation of said recording unit and said reproducing unit.
